(19) United States
(12) Patent Application Publication
(10) Pub. No.: US 2024/0415361 A1
(43) Pub. Date: Dec. 19, 2024

(54) MOP CLEANING APPARATUS

(71) Applicant: SAN JING MACHINE TECHNOLOGY CO., LTD., Taichung City (TW)

(72) Inventor: Yung-An CHO, Pitou Township (TW)

(73) Assignee: SAN JING MACHINE TECHNOLOGY CO., LTD., Taichung City (TW)

(21) Appl. No.: 18/592,984

(22) Filed: Mar. 1, 2024

(30) Foreign Application Priority Data
Jun. 17, 2023 (TW) 112122844

(51) Int. Cl. A47L 13/50; A47L 13/20; B08B 3/04

(52) U.S. Cl. CPC A47L 13/50; A47L 13/20; B08B 3/041

(57) ABSTRACT

A mop cleaning apparatus defines a cleaning compartment and a water-storing compartment. A piston pump has a cylinder defining a water-drawing space, a piston member disposed in the cylinder, a water-outlet opening communicating with the water-drawing space, and a water-inlet valve with a water-inlet opening communicating with the water-drawing space. A water-inlet pipe interconnects the water-inlet opening and the water-storing compartment. A water-outlet pipe interconnects the water-outlet opening and the cleaning compartment. The piston member is movable between a water-drawing position and a water-discharging position. When the piston member is at the water-drawing position, the water-inlet valve is opened so that water in the water-storing compartment is drawn into the water-drawing space through the water-inlet pipe. When the piston member is at the water-discharging position, the water-inlet valve is closed so that water in the water-drawing space is discharged through the water-outlet pipe into the cleaning compartment.

### CROSS-REFERENCE TO RELATED APPLICATION

This application claims priority to Taiwanese Invention Patent application Ser. No. 11/212,2844, filed on Jun. 17, 2023, the entire disclosure of which is incorporated by reference herein.

### FIELD

The disclosure relates to a cleaning apparatus, and more particularly to a mop cleaning apparatus.

### BACKGROUND

As shown in FIG. 14, an existing mop cleaning apparatus (as disclosed in Taiwanese Patent No. TW M625797U) includes a housing unit 91, a driving unit 92, a water-drawing pump 93, and a rotary unit 94. The housing unit 91 has a water-storing compartment 911 and a cleaning compartment 912. The driving unit 92 includes a base 921, an actuating rod 922, and a linkage set 923. The water-drawing pump 93 has a pump casing 931, a vane wheel 932, a water-inlet pipe 933, and a water-outlet pipe 934. When the actuating rod 922 is driven to slide relative to the base 921, the linkage set 923 is rotated to draw water from the water-storing compartment 911 to the cleaning compartment 912 through the water-inlet pipe 933 and the water-outlet pipe 934, so a mop head of a mop 95 may be rotated in the cleaning compartment 912 and be cleaned.

However, there is room for improvement to the existing mop cleaning apparatus.

### SUMMARY

Therefore, an object of the disclosure is to provide a mop cleaning apparatus that can improve water-drawing and water-discharging effects for cleaning a mop head of a mop.

According to the disclosure, a mop cleaning apparatus includes a container unit and a water-drawing unit.

The container unit includes a container wall that defines a cleaning compartment adapted to receive a mop head of a mop, and a water-storing compartment.

The water-drawing unit is mounted in the container unit, and includes a piston pump, a water-inlet pipe, and a water-outlet pipe.

The piston pump has a cylinder, a piston member, a water-outlet opening, and a water-inlet valve. The cylinder defines a piston-receiving space and a water-drawing space that is in fluid communication with the piston-receiving space. The piston member is movably disposed in the piston-receiving space. The water-outlet opening is in fluid communication with the water-drawing space. The water-inlet valve is connected to the cylinder, and defines a water-inlet opening that is in fluid communication with the water-drawing space.

The water-inlet pipe is connected to the water-inlet valve, and fluidly interconnects the water-inlet opening and the water-storing compartment.

The water-outlet pipe fluidly interconnects the water-outlet opening and the cleaning compartment.

The piston member is movable relative to the cylinder between a water-drawing position where the piston member is distal from the water-drawing space and a water-discharging position where the piston member is proximate to the water-drawing space.

When the piston member is at the water-drawing position, the water-

inlet valve is opened so that water in the water-storing compartment is drawn into the water-drawing space through the water-inlet pipe.

When the piston member is at the water-discharging position, the water-inlet valve is closed so that water in the water-drawing space is discharged through the water-outlet pipe into the cleaning compartment for cleaning the mop head.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic perspective view illustrating a mop cleaning apparatus according to a first embodiment of the disclosure.

FIG. 2 is a fragmentary sectional view of the first embodiment illustrating the mop cleaning apparatus adapted to clean a mop.

FIG. 3 is a sectional view of a piston pump of the first embodiment illustrating a water-inlet valve in an opened state when a piston member is moved to a water-drawing position relative to a cylinder.

FIG. 4 is a sectional view from another viewing angle of the piston pump of the first embodiment illustrating a water-outlet valve in a closed state when the piston member is moved to the water-drawing position relative to the cylinder.

FIG. 5 is a sectional view similar to FIG. 3, but illustrating the water-inlet valve in a closed state when the piston member is moved to a water-discharging position relative to the cylinder.

FIG. 6 is a sectional view similar to FIG. 4, but illustrating the water-outlet valve in an opened state when the piston member is moved to a water-5 discharging position relative to the cylinder.

FIG. 7 is a sectional view of the piston pump of the first embodiment illustrating a variant of the water-inlet valve in the opened state when the piston member is moved to the water-drawing position.

FIG. 8 is a sectional view from another viewing angle of the piston pump of the first embodiment illustrating a variant of the water-outlet valve in the closed state when the piston member is moved to the water-drawing position.

FIG. 9 is a sectional view similar to FIG. 7, but illustrating the variant of the water-inlet valve in the closed state when the piston member is moved to the water-discharging position.

FIG. 10 is a sectional view similar to FIG. 8, but illustrating the variant of the water-outlet valve in the opened state when the piston member is moved to the water-discharging position.

FIGS. 11 to 13 illustrate a mop cleaning apparatus according to a second embodiment of the disclosure.

FIG. 14 is a fragmentary sectional view illustrating an existing mop cleaning apparatus and a mop.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

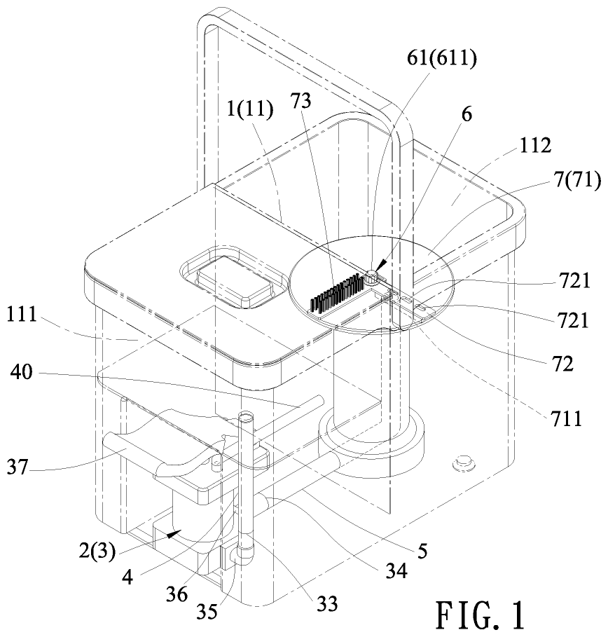

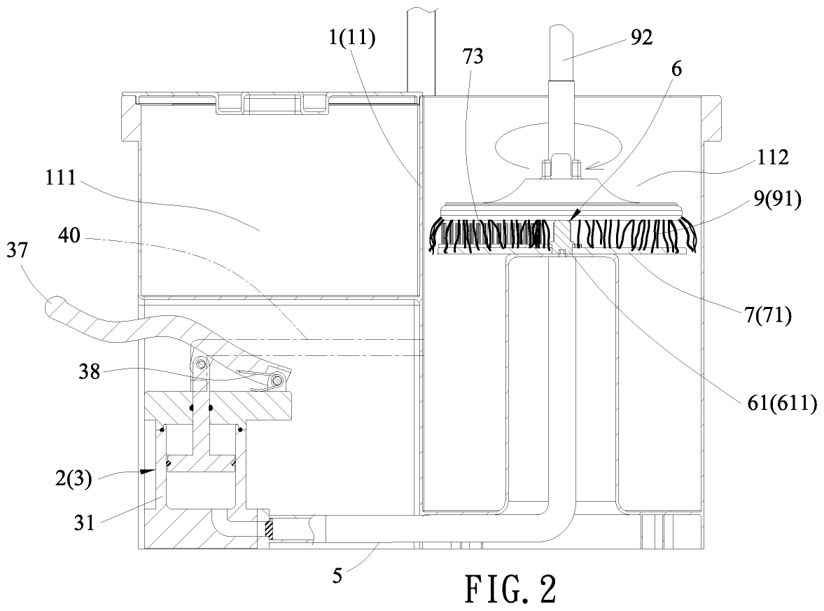

Referring to FIGS. 1 and 2, a mop cleaning apparatus according to a first embodiment of the disclosure is adapted for cleaning a mop head 91 of a mop 9. The mop head 91 has a plurality of cotton strands.

In this embodiment, the mop cleaning apparatus includes a container unit 1, a water-drawing unit 2, a rotary unit 6, and a water-guiding unit 7.

The container unit 1 includes a container wall 11 that defines a cleaning compartment 112 adapted to receive the mop head 91 of the mop 9, and a water-storing compartment 111.

The water-drawing unit 2 is mounted in the container unit 1, and includes a piston pump 3, a water-inlet pipe 4, and a water-outlet pipe 5.

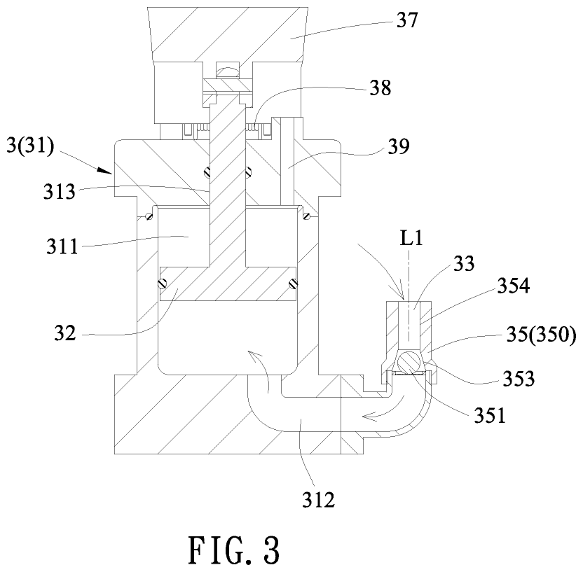

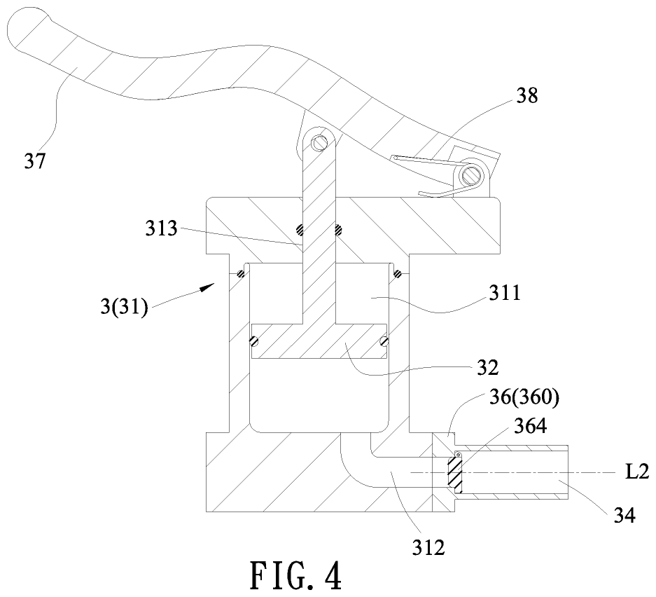

Referring to FIGS. 3 and 4 in combination with FIGS. 1 and 2, the piston pump 3 has a cylinder 31, a piston member 32, a water-inlet valve 35, a water-outlet valve 36, a pedal plate 37, a spring 38, and a release pressure pipe 40. The cylinder 31 defines a piston-receiving space 311 and a water-drawing space 312 that is in fluid communication with the piston-receiving space 311. The cylinder 31 further has a through hole 313 and a release pressure channel 39. The through hole 313 communicates with the piston-receiving space 311. The release pressure channel 39 is spaced apart from the through hole 313, and interconnects the piston-receiving space 311 and an external environment outside the piston-receiving space 311. The piston member 32 is movably disposed in the piston-receiving space 311. The water-inlet valve 35 is connected to the cylinder 31, and defines a water-inlet opening 33 that is in fluid communication with the water-drawing space 312. The water-outlet valve 36 is connected to the cylinder 31 distally from the water-inlet valve 35, and defines a water-outlet opening 34 that is in fluid communication with the water-drawing space 312. The water-inlet pipe 4 is connected to the water-inlet valve 35, and fluidly interconnects the water-inlet opening 33 and the water-storing compartment 111. The water-outlet pipe 5 is connected to the water-outlet valve 36, and fluidly interconnects the water-outlet opening 34 and the cleaning compartment 112. The pedal plate 37 is pivotally connected between the cylinder 31 and the piston member 32. The spring 38 is mounted between the pedal plate 37 and the cylinder 31, and restores the pedal plate 37. The release pressure pipe 40 interconnects the release pressure channel 39 and the cleaning compartment 112. In this embodiment, each of the water-inlet valve 35 and the water-outlet valve 36 is a check valve. The release pressure channel 39 and the release pressure pipe 40 cooperate with each other to adjust pressure inside the cylinder 31.

It should be noted that, in some embodiments, the piston pump 3 may further has an auxiliary spring (not shown) disposed inside the cylinder 31 and abutting against a bottom end of the piston member 32 to enhance restoration of the pedal plate 37.

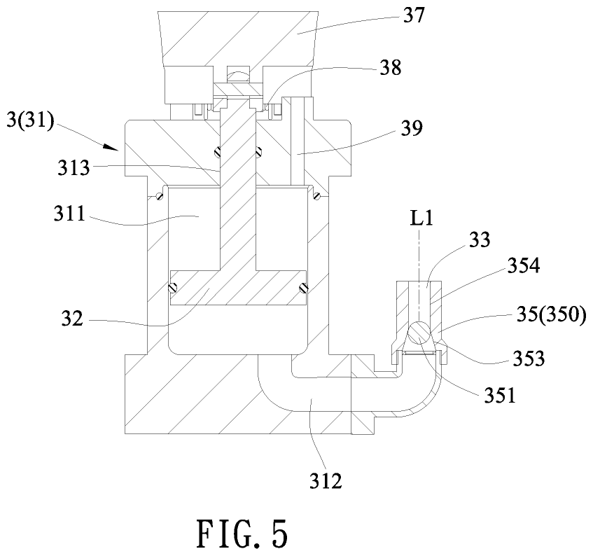

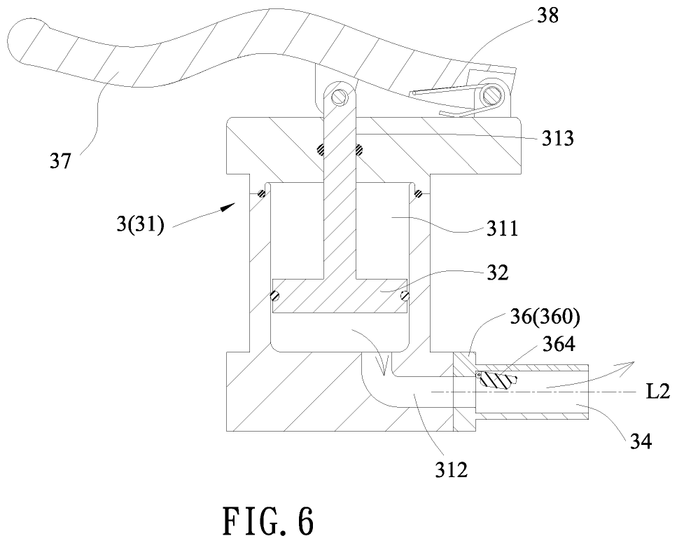

As shown in FIGS. 5 and 6 in combination with FIGS. 3 and 4, the piston member 32 is movable relative to the cylinder 31 between a water-drawing position (see FIGS. 3 and 4) where the piston member 32 is distal from the water-drawing space 312 and a water-discharging position (see FIGS. 5 and 6) where the piston member 32 is proximate to the water-drawing space 312. When the piston member 32 is at the water-drawing position, the water-inlet valve 35 is opened so that water in the water-storing compartment 111 is drawn into the water-drawing space 312 through the water-inlet pipe 4. When the piston member 32 is at the water-discharging position, the water-inlet valve 35 is closed so that water in the water-drawing space 312 is discharged through the water-outlet pipe 5 into the cleaning compartment 112 for cleaning the mop head 91.

As shown in FIGS. 3 and 5, the water-inlet valve 35 has a first valve body 350 and a first sealing member 351. The first valve body 350 extends along a first axis (L1), and has a first hollow portion 354 and a first enlarged hollow portion 353. The first enlarged hollow portion 353 extends from the first hollow portion 354 and has an internal diameter greater than an internal diameter of the first hollow portion 354. The first sealing member 351 is disposed movably within the first enlarged hollow portion 353. When the piston member 32 is moved from the water-drawing position (as shown in FIG. 3) to the water-discharging position (as shown in FIG. 5), the first sealing member 351 is moved to close the water-inlet opening 33, so that the water-inlet valve 35 is closed. In this embodiment, the first sealing member 351 is formed as one of a ball shape and a cone shape. When the piston member 32 is not moved to the water-discharging position or is at the water-drawing position (see FIG. 3), the first sealing member 351 may fall to open the water-inlet opening 33.

As shown in FIGS. 4 and 6, the water-outlet valve 36 has a second valve body 360 and a second sealing plate 364. The second valve body 360 extends along a second axis (L2) perpendicular to the first axis (L1), and is hollow. The second sealing plate 364 is disposed movably within the second valve body 360 distally from the water-drawing space 312. When the piston member 32 is moved from the water-discharging position (see FIG. 6) to the water-drawing position (see FIG. 4), the second sealing plate 364 is moved to close the water-outlet opening 34, so that the water-outlet valve 36 is closed.

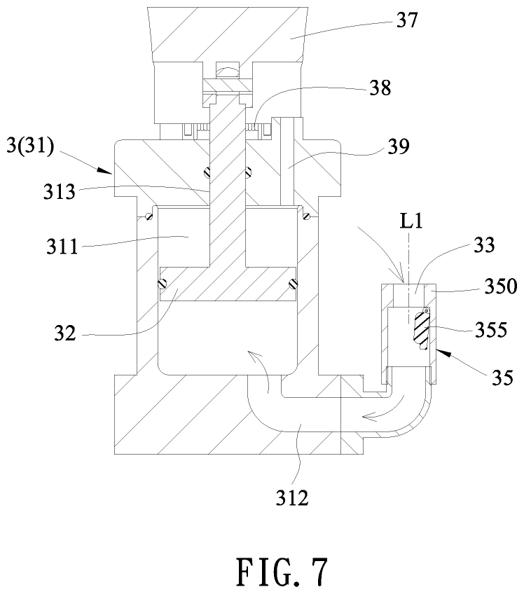

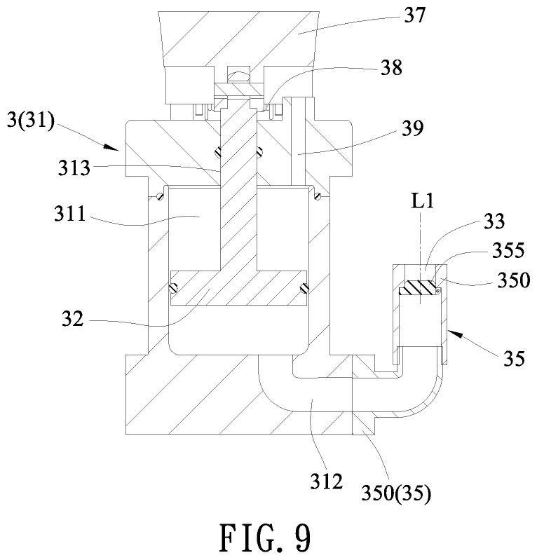

FIGS. 7 and 9 illustrate a variant of the water-inlet valve 35. The variant of the water-inlet valve 35 has a first valve body 350 that extends along the first axis (L1) and that is hollow, and a first sealing plate 355 that is disposed movably within the first valve body 350 distally from the water-drawing space 312. When the piston member 32 is moved from the water-drawing position (see FIG. 7) to the water-discharging position (see FIG. 9), the first sealing plate 355 is moved to close the water-inlet opening 33, so that the water-inlet valve 35 is closed.

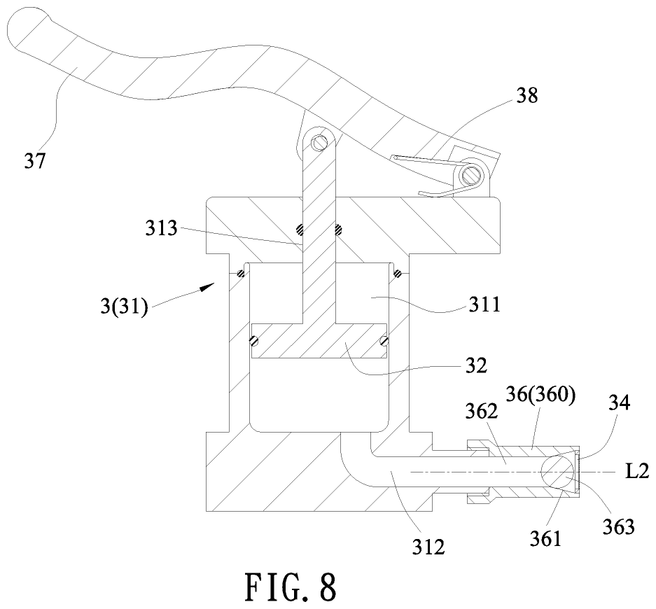

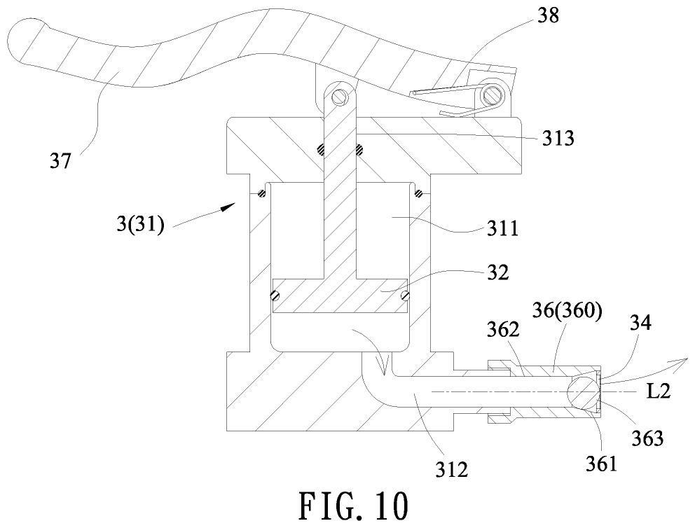

FIGS. 8 and 10 illustrate a variant of the water-outlet valve 36. The variant of the water-outlet valve 36 has a second valve body 360 and a second sealing member 363. The second valve body 360 extends along the second axis (L2), and has a second enlarged hollow portion 361 and a second hollow portion 362. The second hollow portion 362 extends from the second enlarged hollow portion 361 and has an internal diameter smaller than an internal diameter of the second enlarged hollow portion 361. The second sealing member 363 is disposed movably within the second enlarged hollow portion 361. When the piston member 32 is moved from the water-discharging position (see FIG. 10) to the water-drawing position (see FIG. 8), the second sealing member 363 is moved to close the water-outlet opening 34, so that the water-outlet valve 36 is closed. The second sealing member 363 is formed as one of a ball shape and a cone shape.

In some embodiments, the water-outlet valve 36 is omitted. By virtue of the water-inlet valve 35 being opened when the piston member 32 is at the water-drawing position and being closed when the piston member 32 is at the water-discharging position, the mop cleaning apparatus of the disclosure may still achieve water-drawing and water-discharging effects.

Referring back to FIGS. 1 and 2, the rotary unit 6 is mounted to the container unit 1 and includes a rotary rod 61. The rotary rod 61 is rotatably disposed in the cleaning compartment 112 and has a connection portion 611 disposed adjacent to the water-outlet pipe 5. The connection portion 611 is adapted to be removably connected to the mop head 91 such that the mop head 91 is rotatable in the cleaning compartment 112. The mop 9 has a handle rod 92 connected to the mop head 91. When the handle rod 92 is driven to linearly move relative to the container unit 1, the mop head 91 and the connection portion 611 are driven to rotate together. Since the mop 9 is well known in the art (as disclosed in Taiwanese Utility Model Patent No. M368410, M415686, and M446606), structurally detailed description thereof is omitted herein for brevity.

The water-guiding unit 7 is disposed in the cleaning compartment 112, and includes a positioning cover 71, a water-guiding member 72, and a brush set 73. The positioning cover 71 is disposed in the cleaning compartment 112, is mounted to the container wall 11, and has a water-guiding recess 711 in fluid communication with the water-outlet pipe 5. The water-guiding member 72 is disposed on and extends along a top surface of the positioning cover 71. The water-guiding member 72 has a plurality of water-spraying holes 721 fluidly interconnecting the water-guiding recess 711 and the cleaning compartment 112. The brush set 73 is disposed on the positioning cover 71 and is adjacent to the water-guiding member 72. The connection portion 611 of the rotary rod 61 extends through and protrudes outwardly from the top surface of the positioning cover 71.

Referring back to FIGS. 5 and 6, in use, the pedal plate 37 is first operated to move the piston member 32 to the water-discharging position, so a discharging force is generated such that the water-outlet valve 36 is opened and the water-inlet valve 35 is closed, thereby discharging air in the water-drawing space 312.

Referring back to FIGS. 3 and 4, when the pedal plate 37 is released, and when the spring 38 restores the pedal plate 37 such that the piston member 32 is moved to the water-drawing position, a drawing force is generated such that the water-inlet valve 35 is opened and the water-outlet valve 36 is closed, thereby drawing the water in the water-storing compartment 111 into the water-drawing space 312 through the water-inlet pipe 4.

As shown in FIGS. 5 and 6, when the pedal plate 37 is operated again to move the piston member 32 to the water-discharging position, a discharging force is generated and causes the water-outlet valve 36 to be opened and the water-inlet valve 35 to be closed so that the water drawn in the water-drawing space 312 may be discharged through the water-outlet pipe 5 into the cleaning compartment 112 for cleaning the mop head 91.

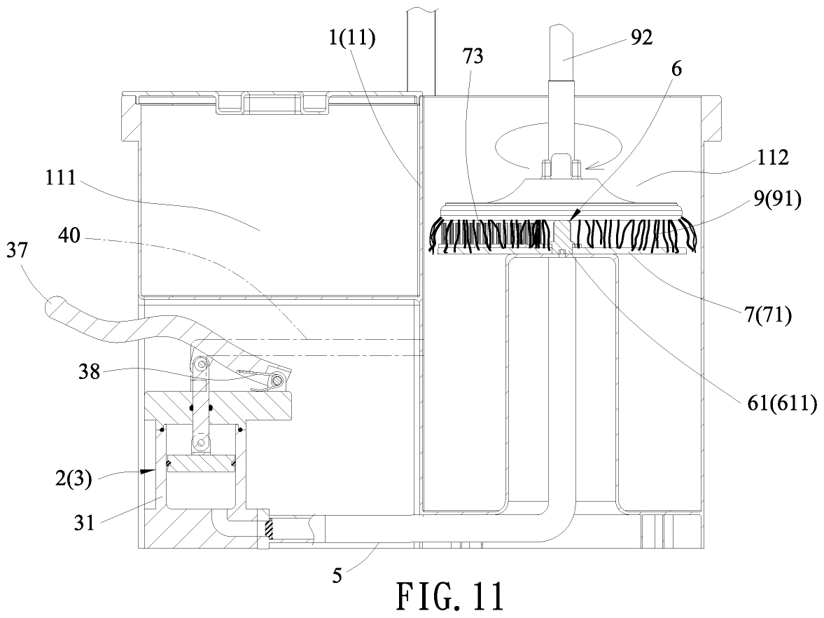

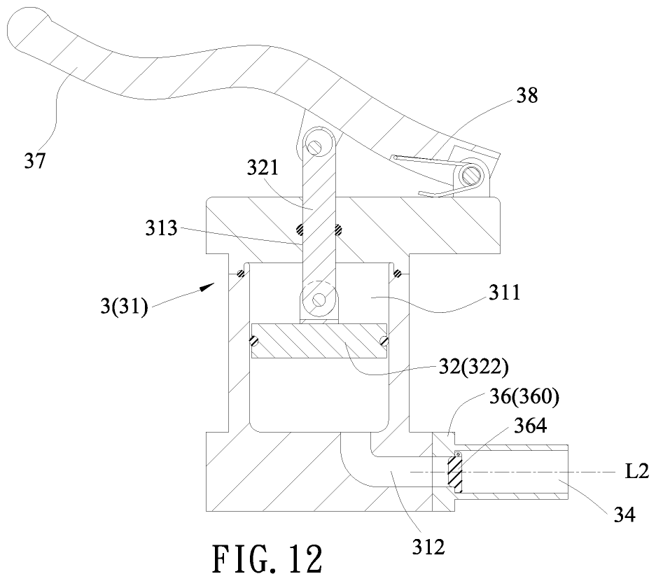

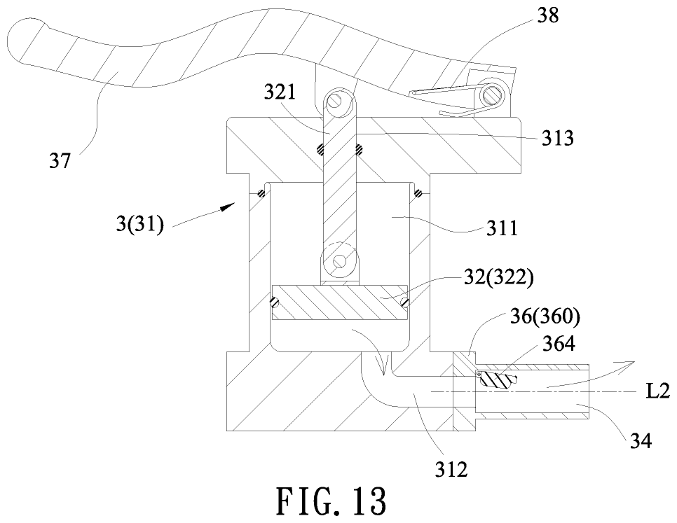

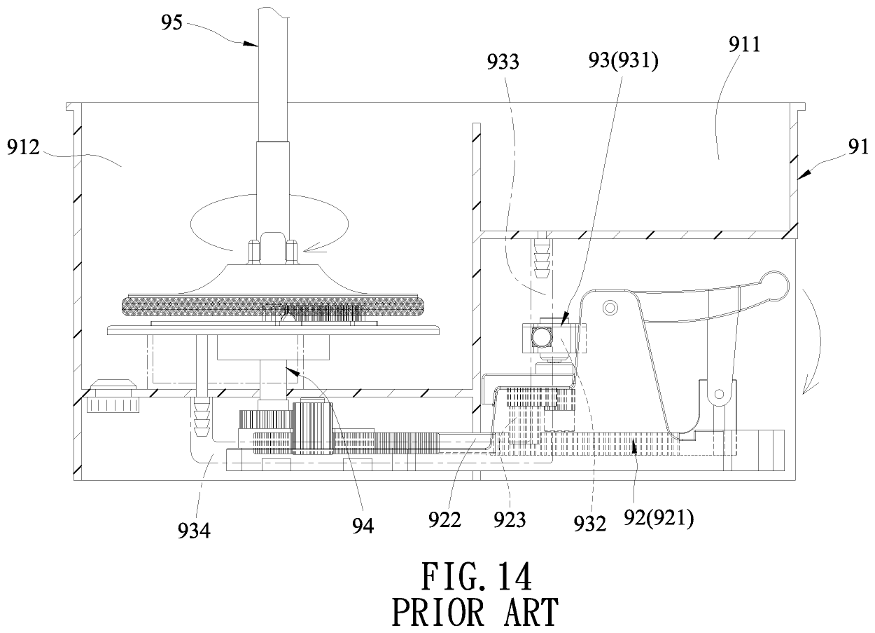

FIGS. 11 to 13 illustrate a mop cleaning apparatus according to a second embodiment of the disclosure, which has a structure generally similar to that of the first embodiment. However, in this embodiment, the piston member 32 has a coupling rod portion 321 and a piston head portion 322. The coupling rod portion 321 movably extends through the through hole 313 and is pivotally connected to the pedal plate 37. The piston head portion 322 is disposed within the piston-receiving space 311 and is pivotally connected to the coupling rod portion 321.

In the second embodiment, by virtue of the coupling rod portion 321 being pivotally connected to the pedal plate 37 and the piston head portion 322 being pivotally connected to the coupling rod portion 321, when the piston member 32 is driven by the pedal plate 37 to move, smooth movement of the piston head portion 322 relative to the cylinder 31 may be enhanced.

The mop cleaning apparatus of the disclosure has following advantages.

(1) The water-drawing unit 2 is mounted in the container unit 1, and the piston member 32 of the piston pump 3 is moved relative to the cylinder 31 between the water-drawing position and the water-discharging position. When the piston member 32 is moved to the water-drawing position, the water-inlet valve 35 is opened, the water-outlet valve 36 is closed, and the water in the water-storing compartment 111 is drawn into the water-drawing space 312 through the water-inlet pipe 4. When the piston member 32 is moved to the water-discharging position, the water-inlet valve 35 is closed, the water-outlet valve 36 is opened, and the water in the water-drawing space 312 is discharged through the water-outlet pipe 5 into the cleaning compartment 112 to clean the mop head 91. As a result, water-drawing and water-discharging effects may be satisfactorily achieved by the mop cleaning apparatus of the disclosure.

(2) When the piston member 32 is moved from the water-drawing position to the water-discharging position, because the water-inlet opening 33 of the water-inlet valve 35 is closed, the water-discharging effect may be satisfactorily achieved.

(3) When the piston member 32 is moved from the water-discharging position to the water-drawing position, because the water-outlet opening 34 of the water-outlet valve 36 is closed, the water-drawing effect may be satisfactorily achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another 5 one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A mop cleaning apparatus, comprising:
a container unit including
a container wall that defines a cleaning compartment adapted to receive a mop head of a mop, and a water-storing compartment; and
a water-drawing unit mounted in said container unit, and including
a piston pump that has
a cylinder defining a piston-receiving space and a water-drawing space that is in fluid communication with said piston-receiving space,
a piston member movably disposed in said piston-receiving space,
a water-outlet opening in fluid communication with said water-drawing space, and
a water-inlet valve connected to said cylinder, and defining a water-inlet opening that is in fluid communication with said water-drawing space,
a water-inlet pipe that is connected to said water-inlet valve, and that fluidly interconnects said water-inlet opening and said water-storing compartment, and
a water-outlet pipe that fluidly interconnects said water-outlet opening and said cleaning compartment;
wherein said piston member is movable relative to said cylinder between a water-drawing position where said piston member is distal from said water-drawing space and a water-discharging position where said piston member is proximate to said water-drawing space;
wherein when said piston member is at the water-drawing position, said water-inlet valve is opened so that water in said water-storing compartment is drawn into said water-drawing space through said water-inlet pipe; and
wherein when said piston member is at the water-discharging position, said water-inlet valve is closed so that water in said water-drawing space is discharged through said water-outlet pipe into said cleaning compartment for cleaning the mop head.

2. The mop cleaning apparatus as claimed in claim 1, wherein:
said piston pump further has a water-outlet valve that is connected to said cylinder, and that defines said water-outlet opening;
said water-outlet pipe is connected to said water-outlet valve; and
each of said water-inlet valve and said water-outlet valve is a check valve.

3. The mop cleaning apparatus as claimed in claim 2, wherein:
said water-inlet valve has
a valve body that extends along an axis, and that has
a hollow portion, and
an enlarged hollow portion extending from said hollow portion and having an internal diameter greater than an internal diameter of said hollow portion, and
a sealing member that is disposed movably within said enlarged hollow portion; and
when said piston member is moved from the water-drawing position to the water-discharging position, said sealing member is moved to close said water-inlet opening, so that said water-inlet valve is closed.

4. The mop cleaning apparatus as claimed in claim 3, wherein said sealing member is formed as one of a ball shape and a cone shape.

5. The mop cleaning apparatus as claimed in claim 2, wherein:
said water-outlet valve has
a valve body that extends along an axis, and that has
an enlarged hollow portion, and
a hollow portion extending from said enlarged hollow portion and having an internal diameter smaller than an internal diameter of said enlarged hollow portion, and
a sealing member that is disposed movably within said enlarged hollow portion; and
when said piston member is moved from the water-discharging position to the water-drawing position, said sealing member is moved to close said water-outlet opening, so that said water-outlet valve is closed.

6. The mop cleaning apparatus as claimed in claim 5, wherein said sealing member is formed as one of a ball shape and a cone shape.

7. The mop cleaning apparatus as claimed in claim 2, wherein:
said water-inlet valve has
a valve body that extends along an axis and that is hollow, and
a sealing plate that is disposed movably within said valve body; and
when said piston member is moved from the water-drawing position to the water-discharging position, said sealing plate is moved to close said water-inlet opening, so that said water-inlet valve is closed.

8. The mop cleaning apparatus as claimed in claim 2, wherein:
said water-outlet valve has
a valve body that extends along an axis, and that is hollow, and
a sealing plate that is disposed movably within said valve body; and
when said piston member is moved from the water-discharging position to the water-drawing position, said sealing plate is moved to close said water-outlet opening, so that said water-outlet valve is closed.

9. The mop cleaning apparatus as claimed in claim 1, wherein said piston pump further has a pedal plate that is pivotally connected between said cylinder and said piston member, and a spring that is mounted between said pedal plate and said cylinder and that restores said pedal plate.

10. The mop cleaning apparatus as claimed in claim 9, wherein:
said cylinder further has a through hole communicating with said piston-receiving space; and
said piston member has a coupling rod portion movably extending through said through hole and pivotally connected to said pedal plate, and a piston head portion disposed within said piston-receiving space and pivotally connected to said coupling rod portion.

11. The mop cleaning apparatus as claimed in claim 1, further comprising a rotary rod that is rotatably disposed in said cleaning compartment and that has a connection portion disposed adjacent to said water-outlet pipe, said connection portion being adapted to be removably connected to the mop head such that the mop head is rotatable in said cleaning compartment.
